(19) United States
(12) Patent Application Publication
(10) Pub. No.: US 2025/0276885 A1
(43) Pub. Date: Sep. 4, 2025

(54) LIFT DEVICE

(71) Applicant: TEREX SOUTH DAKOTA, INC., Watertown, SD (US)

(72) Inventors: Ankith RAVISHANKAR, Bengaluru (IN); Abin PETER, Bengaluru (IN); Prathap MURALIDHARA, Bengaluru (IN); Yogesh RJ, Bengaluru (IN); Charles SUNNY, Bengaluru (IN); Sendil MUTHUSWAMY, Bengaluru (IN)

(73) Assignee: TEREX SOUTH DAKOTA, INC., Watertown, SD (US)

(21) Appl. No.: 18/593,237

(22) Filed: Mar. 1, 2024

(51) Int. Cl. B66F 11/04

(52) U.S. Cl. CPC B66F 11/046

(57) ABSTRACT

A lift device may comprise a support member arrangement including a first upright support member, a second upright support member movably associated with the first upright support member, and a third upright support member movably associated with the second upright support member. The lift device may also include a drive system that is operable to move the support member arrangement between a lowered position and a raised position. The drive system may include first and second drive members and an actuator for moving the first and second drive members. The first drive member may be movably associated with the second upright support member and fixedly connected to the first upright support member and the third upright support member, and the second drive member may be movably associated with the third upright support member and fixedly connected to the second upright support member.

### TECHNICAL FIELD

The disclosure relates to a lift device.

### BACKGROUND

Example lift devices are disclosed in U.S. Pat. No. 5,803,204.

### SUMMARY

A lift device according to the disclosure may comprise a support member arrangement including a first upright support member, a second upright support member movably associated with the first upright support member, and a third upright support member movably associated with the second upright support member. The lift device may also include a drive system that is operable to move the support member arrangement between a lowered position and a raised position. The drive system may include first and second drive members and an actuator for moving the first and second drive members. The first drive member may be movably associated with the second upright support member and fixedly connected to the first upright support member and the third upright support member, and the second drive member may be movably associated with the third upright support member and fixedly connected to the second upright support member. The first and second drive members are configured to cooperate to provide synchronized movement of the second and third upright support members.

While exemplary embodiments are illustrated and disclosed, such disclosure should not be construed to limit the claims. It is anticipated that various modifications and alternative designs may be made without departing from the scope of the disclosure.

### BRIEF DESCRIPTION OF THE DRAWINGS

FIG. 1 is a perspective view of a lift according to the disclosure including a support member arrangement shown in a lowered position;

FIG. 2 is a perspective view of the lift showing the support member arrangement in a raised position, wherein the support member arrangement includes first, second and third upright support members;

FIG. 3A is a front view of the support member arrangement, with the second upright support member shown in section and the third upright support member partially broken away to show first and second drive members of a drive system positioned inside of the second and third upright support members, respectively;

FIG. 3B is a top view of the support member arrangement and drive system;

FIG. 4 is a schematic diagram of the support member arrangement;

FIG. 5 is a perspective view of a fastener for connecting one of the drive members of the support member arrangement to one of the upright support members;

FIG. 6 is an exploded perspective view of the fastener of FIG. 5;

FIG. 7 is a front or rear view of the fastener of FIG. 5 connected to one of the drive members;

FIG. 8 is a front view of an actuator of the drive system mounted on the third upright support member;

FIG. 9 is a perspective view of a transmission of the actuator;

FIG. 10 is a front view of the third upright support member, showing the transmission and the second drive member of the drive system mounted on the third upright support member; and

FIG. 11 is an interior perspective view of a portion of the third upright support member and the second drive member.

### DETAILED DESCRIPTION

As required, detailed embodiments are disclosed herein. However, it is to be understood that the disclosed embodiments are merely exemplary, and that various and alternative forms may be employed. The figures are not necessarily to scale; some features may be exaggerated or minimized to show details of particular components. Therefore, specific structural and functional details disclosed herein are not to be interpreted as limiting, but merely as a representative basis for teaching one skilled in the art.

As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising” specify the presence of stated features, integers, steps, operations, elements, and/or components, but do not preclude the presence or addition of one or more other features, integers, steps, operations, elements, components, and/or groups thereof.

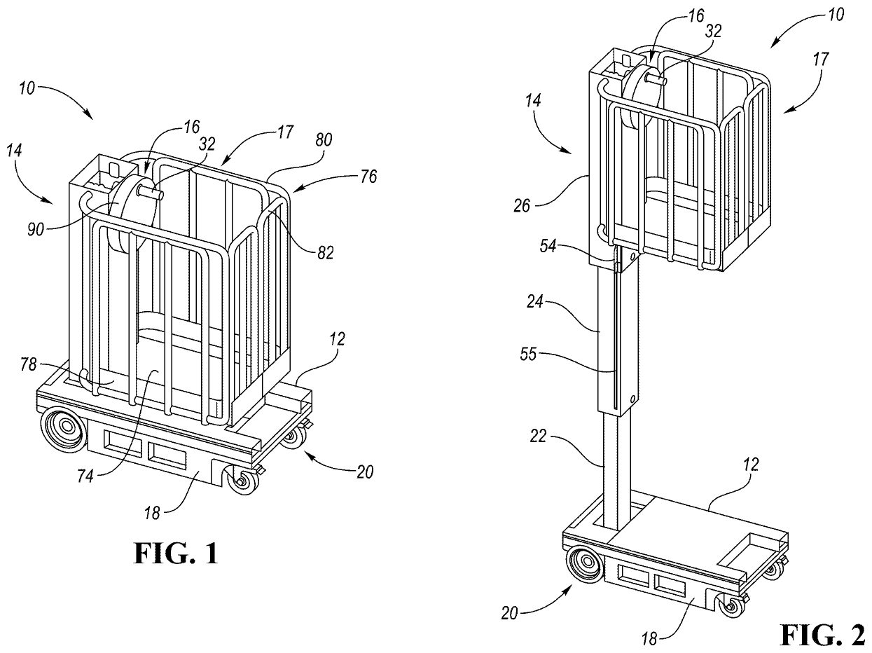

FIGS. 1 and 2 show a lift device or lift 10 according to the disclosure, such as a boom lift or aerial work platform. The lift 10 includes a base 12, a support member arrangement 14 attached to the base 12, a drive system 16 that is operable to move the support member arrangement 14 between a lowered position, shown in FIG. 1, and a raised position, shown in FIG. 2, and a work platform assembly 17 connected to the support member arrangement 14 and configured to receive an operator.

The base 12 is configured to support the support member arrangement 14, along with the rest of the lift 10, and includes a main body 18, such as a rigid support structure, and one or more support members 20, such as wheels, tracks, outriggers, etc., attached to the main body 18. In the illustrated environment, the lift 10 includes multiple support members 20 formed as wheels and associated tires, so that the base 12 is movable. Furthermore, two or more of the wheels are pivotable in order to steer the base 12.

The support member arrangement 14 includes multiple support members, such as upright support members, wherein one or more of the support members are movable with respect to another one of the support members so that the support member arrangement 14 is movable between the lowered position and the raised position. In the illustrated embodiment, for example, the support member arrangement 14 includes a first upright support member 22, such as a lower boom, mast, tube, column, etc., attached to the base 12, a second upright support member 24, such as an intermediate boom, mast, tube, column, etc., movably (e.g., slidably) associated with the first upright support member 22, and a third upright support member 26, such as an upper boom, mast, tube, column, etc., movably (e.g., slidably) associated with the second upright support member 24. The upright support members 22, 24 and 26 may each be made of any suitable material, such as metal (e.g., steel, stainless steel, aluminum, etc.). In the illustrated embodiment, the first upright support member 22 is fixedly attached to the base 12, such as with fasteners and/or by welding, and the second upright support member 24 and the third upright support member 26 are each movable with respect to the other upright support members. Furthermore, in the illustrated embodiment, the second upright support member 24 is telescopically slidable with respect to the first upright support member 22 (e.g., the second upright support member 24 is configured to telescopically receive the first upright support member 22 when the support member arrangement 14 moves from the raised position toward the lowered position). Likewise, in the illustrated embodiment, the third upright support member 26 is telescopically slidable with respect to the second upright support member 24 (e.g., the third upright support member 26 is configured to telescopically receive the second upright support member 24 when the support member arrangement 14 moves from the raised position toward the lowered position. In the illustrated embodiment, the upright support members 22, 24 and 26 are also generally concentrically mounted with respect to each other. In another embodiment, two or more of the upright support members 22, 24 and 26 may be mounted adjacent to each other such that the two or more upright support members 22, 24 and 26 are not concentric or axially aligned with respect to each other.

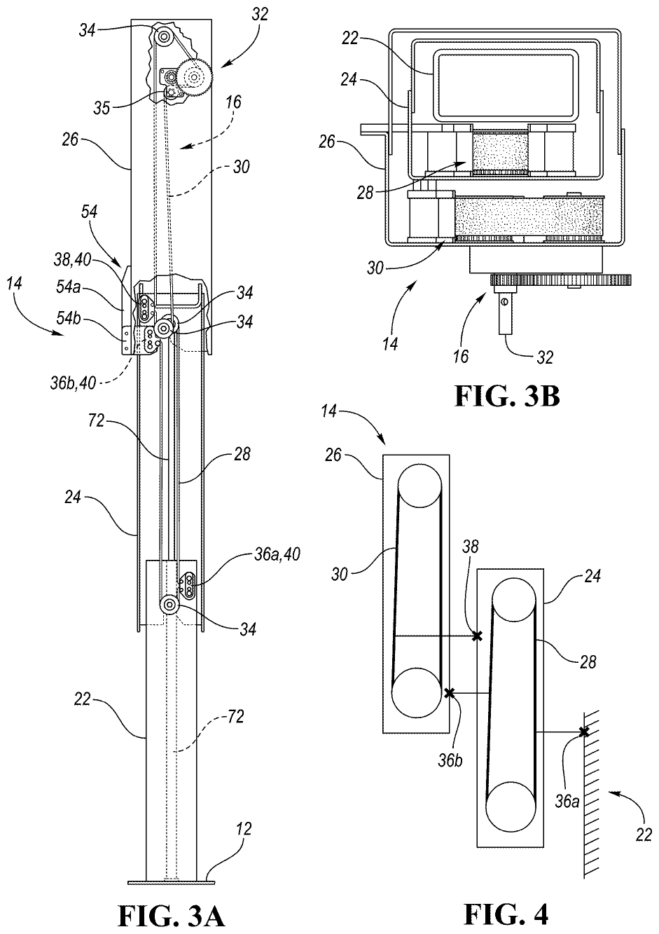

Referring to FIGS. 1-4, the drive system 16 includes movable first and second drive members 28 and 30, respectively, and an actuator 32 for moving the drive members 28, 30. For example, the first drive member 28 may be a lower drive member movably associated the second upright support member 24, and the second drive member 30 may be an upper drive member movably associated with the third upright support member 26 and that extends above the lower drive member. Each drive member 28, 30 may have any suitable form or configuration, such as a strand, belt, chain, cable, or other flexible member, or any other suitable drive member. As a more detailed example, each drive member 28, 30 may be a continuous drive member that is movable (e.g., circulatable or reciprocatable) with respect to one or more rotatable members 34, such as pulleys, rollers, wheels, sheaves, etc. In the illustrated embodiment, the first drive member 28 is movable about or at least partially around two rotatable members 34 attached at opposite ends of the second upright support member 24 (e.g., mounted on an interior surface of the second upright support member 24), and the second drive member 30 is movable about or at least partially around two rotatable members 34 attached at opposite ends of the third upright support member 26 (e.g., mounted on an interior surface of the third upright support member 26), so that a portion of each drive member 28, 30 may reciprocate (e.g., move back and forth) between the respective two rotatable members 34. In the illustrated embodiment, the drive system 16 also includes an idler rotatable member 35, such as a pulley, roller, wheel, sheave, etc., for the second drive member 30 that is positioned between the rotatable members 34 associated with the second drive member 30. In addition, in the embodiment shown in FIGS. 3A and 3B, the first drive member 28 is positioned or extends between the second upright support member 24 and the first upright support member 22 (e.g., between the interior surface of the second upright support member 24 and an exterior surface, such as a front face, of the first upright support member 22), and the second drive member 30 is positioned or extends between the third upright support member 26 and the second upright support member 24 (e.g., between the interior surface of the third upright support member 26 and an exterior surface, such as a front face, of the second upright support member 24).

In the illustrated embodiment, the first drive member 28 is movably received or positioned within the second upright support member 24 and fixedly connected to the first upright support member 22 at a fixed connection location 36a (e.g., within the second upright support member 24) and to the third upright support member 26 at a fixed connection location 36b (e.g., within the third upright support member 26 or on an exterior of the third upright support member 26), and the second drive member 30 is movably received or positioned within the third upright support member 26 and fixedly connected to the second upright support member 24 at a fixed connection location 38 (e.g., within the third upright support member 26). With such a configuration, load from the third upright support member 26 may be transferred to one side of the first drive member 28, and force or tension in the second drive member 30 resulting from the actuator 32 may be transferred to the second support member 24. In addition, the first and second drive members 28 and 30, respectively, are configured to cooperate to provide synchronized movement of the second and third upright support members upon actuation by the actuator 32.

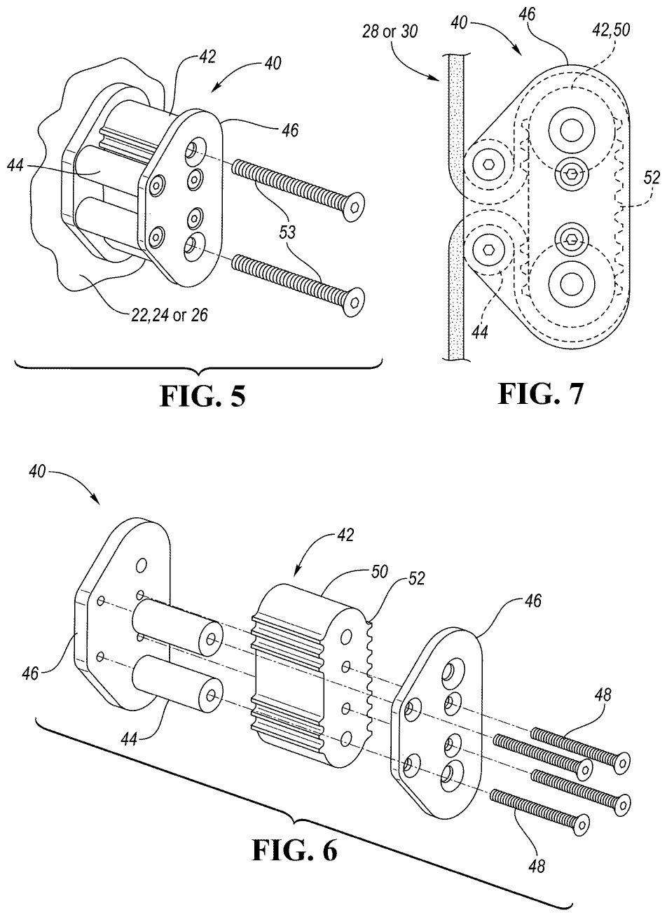

While the drive members 28, 30 may be fixedly connected to the upright support members 22, 24 and/or 26 in any suitable manner, such as with any suitable connectors or fasteners (e.g., clamps, brackets, screws, bolts and nuts, etc.), FIGS. 5-7 show a connector configured as a clamp arrangement or clamp 40 according to the disclosure that may be particularly useful for fixedly connecting the first drive member 28 to the first upright support member 22 and/or the third upright support 26, and/or for fixedly connecting the second drive member 30 to the second upright support member 24. In the illustrated embodiment, the clamp 40 includes a primary or first clamp member 42, such as clamp block, at least partially around which the first drive member 28 or the second drive member 30 may be fixedly wrapped, one or more secondary or second clamp members 44, such as rods, bars, columns etc., positionable adjacent the first clamp member 42, and two clamp plates 46 that receive the first clamp member 42 and the second clamp members 44 therebetween and that are connected together by one or more fasteners 48, such as screws, bolts, etc. The first and second clamp members 42 and 44, respectively, may be made of any suitable material, such as steel, aluminum, plastic, etc., and the first and second clamp members 42 and 44, respectively, cooperate to clamp one or more portions of the first drive member 28 or the second drive member 30 therebetween. The first clamp member 42 and/or the second clamp members 44 may also include one or more grip features, such as projections (e.g., ridges), for gripping the first drive member 28 or the second drive member 30 when the first drive member 28 or the second drive member 30 is wrapped at least partially around the first clamp member 42. In the illustrated embodiment, the first clamp member 42 includes a clamp body 50, such as an oblong clamp body, and multiple projections 52, such as teeth or ridges, that extend outwardly from the clamp body 50. Furthermore, the clamp 40 is configured to be fixedly connected directly or indirectly to one of the upright support members 22, 24, 26, such as with one or more fasteners 53 (e.g., screws, bolts, etc.). For example, the first clamp member 42 and/or the clamp plate(s) 46 may include one or more openings for receiving such fasteners 53.

Returning to FIG. 3A, the clamp 40 at location 36a may be fixedly attached to the exterior surface, e.g., the front face, of the first upright support member 22. The clamp 40 at location 36b may be fixedly attached to a bracket or bracket arrangement 54 (e.g., first and second bracket portions 54a and 54b, respectively) that extends through the second upright support member 24 and is fixedly attached to the third upright support member 26. For example, the bracket 54 may extend through a longitudinally extending slot or channel 55 (shown in FIG. 2) formed in a side of the second upright support member 24. With such a configuration, the bracket 54 may move along the channel 55 when the support member arrangement 14 moves between the lowered and raised positions. The clamp 40 at location 38 may be fixedly attached to the exterior surface, e.g., the front face, of the second upright support member 24.

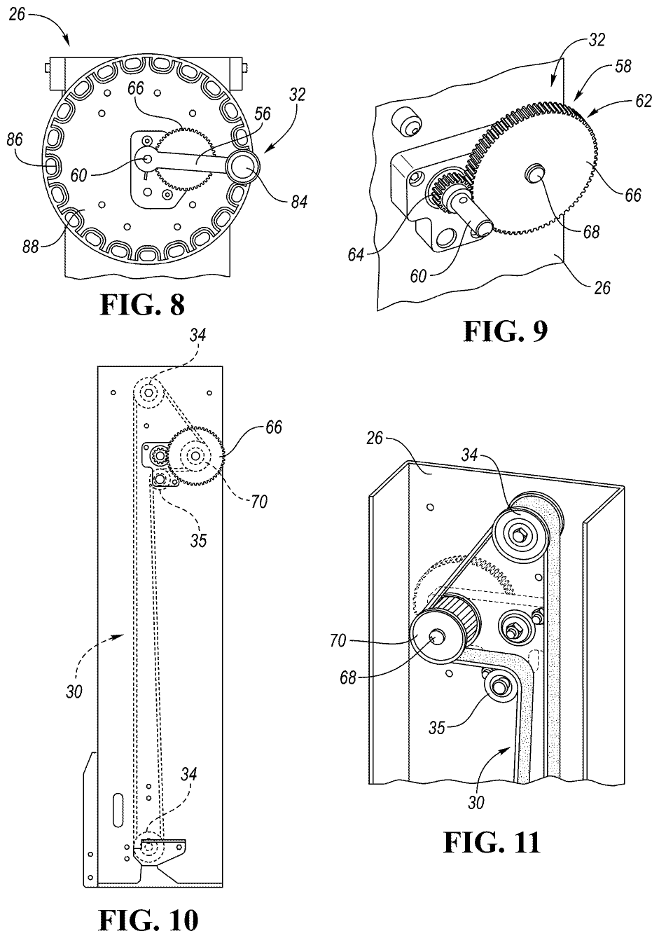

Referring to FIGS. 1, 8 and 9, the actuator 32 may be a manually operable (i.e., hand-operated) actuator for causing movement of the drive members 28 and 30. While the actuator 32 may have any suitable configuration, in the illustrated embodiment, the actuator 32 includes a rotatable member 56, such as a wheel, disc, hand crank or lever arm, rotatably mounted to the third upright support member 26, and a transmission 58 for transferring force between the rotatable member 56 and the second drive member 30. In the illustrated embodiment, the rotatable member 56 comprises a lever arm fixedly mounted on a shaft 60, which is rotatably mounted on the third upright support member 26, and the transmission 58 includes a gear arrangement 62 that cooperates with the lever arm 56 to transfer force from the lever arm 56 to the second drive member 30. For example, the gear arrangement 62 may include a first gear 64 at the end of the lever arm 56 that is rotatable with the lever arm 56, and a second gear 66 that is configured to mesh with the first gear 64. In the embodiment shown in FIGS. 8 and 9, the first gear 64 is fixedly mounted on the shaft 60 to which the lever arm 56 is fixedly mounted, the second gear 66 is connected to a rotatable output shaft 68 that extends through a body of the third upright support member 26, and the output shaft 68 is fixedly connected to a rotatable drive element 70, such as a pulley, ring, wheel, sheave, etc., that is configured to drive the second drive member 30. For example, rotation of the drive element 70 may cause movement of the second drive member 30 due to friction between the drive element 70 and the second drive member 30. As another example, the drive element 70 may have multiple engagement features, such as projections (e.g., ridges or teeth), that are engageable with the second drive member 30 to facilitate moving the second drive member 30 when the drive element 70 rotates, and/or the second drive member 30 may have engagement features, such as projections (e.g., ridges or teeth) and/or notches, that are engageable with the drive element 70 (e.g., with the projections of the drive element 70).

In another embodiment, the actuator 32 may be formed as an automatic actuator (e.g., electric actuator). For example, the actuator 32 may include an electric motor for rotating the first gear 64 or the second gear 66.

Returning to FIG. 3A, the lift 10 may also include one or more additional actuators associated with the support member arrangement 14 and configured to assist with movement of the support member arrangement 14. In the illustrated embodiment, the lift 10 includes an additional or second actuator 72, such as a cylinder or gas spring, or any suitable biasing member or spring, having one end connected to the base 12 and an opposite end connected to the second upright support member 24 (e.g., upper end of the second upright support member 24). With such a configuration, the second actuator 72 may also act as a counterweight, for example, as explained below in detail.

Returning to FIGS. 1 and 2, the work platform assembly 17 is movable with the support member arrangement 14 when the support member arrangement 14 moves between the lowered and raised positions. Specifically, in the illustrated embodiment, the work platform assembly 17 is fixedly mounted on the third upright support member 26. The platform assembly 17 includes a base or work platform 74 (e.g., flat work platform) sized to receive and support an operator thereon, and a railing assembly or frame assembly 76 provided on the platform 74. In the illustrated embodiment, the frame assembly 76 includes multiple toc boards 78, and multiple horizontal and vertical rails 80 that extend around, or partially around, a perimeter of the platform 78. The frame assembly 76 further includes one or more movable (e.g., pivotable) doors 82 to allow operator ingress to, and egress from, the work platform assembly 17.

Referring to FIGS. 1-11, operation of the lift 10 will now be described in more detail. When an operator desires to use the lift 10, she/he may enter the platform assembly 17 by entering through the doors 82. The operator may then actuate the actuator 32 in order to raise the support member arrangement 14 from the lowered position shown in FIG. 1 to the raised position shown in FIG. 2, or any position in between the lowered position and the raised position, so as to raise the platform assembly 17 from a lowered position shown in FIG. 1 to a raised position shown in FIG. 2, or any position in between. For example, referring to FIGS. 1 and 8, when the operator rotates the lever arm 56 in a first direction, such as clockwise in the illustrated configuration, the transmission 58 will cause the second drive member 30 to move, e.g., rotate or circulate, in a second direction opposite the first direction, such as counterclockwise in the embodiment shown in FIGS. 3A, 4 and 10. As a result, the third upright support member 26 will move upwardly because of the fixed interconnection between the second drive member 30 and the second upright support member 24. Likewise, the upward movement of the third upright support member 26 will also cause the second upright support member 24 to move upwardly because of the fixed interconnection between the third upright support member 30 and the first drive member 28 (which will move, e.g., rotate or circulate, in the first direction, e.g., clockwise in the embodiment shown in FIGS. 3A and 4) and the fixed interconnection between the first drive member 28 and the first upright support member 22. Specifically, because of the fixed interconnection between the third upright support member 26 and the first drive member 28, upward movement of the third upright support member 26 will cause the first drive member 28 to move, e.g., rotate or circulate, in the first direction, e.g., clockwise in the embodiment shown in FIGS. 3A and 4, and that movement will cause the second upright support member 24 to move upwardly because of the fixed interconnection between the first drive member 28 and the first upright support member 22.

The second actuator 72 may also assist in upward movement of the second and third upright support members 24 and 26, respectively, by urging the second support member 24 upwardly due to the arrangement of the second actuator 72 between the base 12 and the second upright support member 24. When a desired elevated position of the support member arrangement 14 and/or of the platform assembly 17 is reached, the operator may stop actuating the actuator 32, e.g., stop rotating the lever arm 56, so that movement of the second drive member 30 will stop.

The lift 10 may also be provided with a locking mechanism or device for holding or maintaining the support member arrangement 14 and/or the platform assembly 17 in the desired elevated position. For example, the actuator 32 may be provided with such a locking mechanism or device. As a more specific example, referring to FIG. 8, the lever arm 56 may include a knob 84 having a retractable locking member or element (not shown), such as a pin, rod or other projection, that is engageable with any one of multiple locking features, such as locking apertures 86, formed on or in the third upright support member 26 or a locking member, such as a locking plate 88, fixedly attached to the third upright support member 26. Referring to FIGS. 1 and 2, the actuator 32 may also be provided with a cover 90, such as a rotatable cover, for covering a main body of the lever arm 56 and the locking plate 88.

When it is desired to lower the support member arrangement 14 and the platform assembly 17, the operator may disengage the locking device, if applicable, and then rotate the lever arm 56 in the second direction, e.g., counterclockwise in the embodiment shown in FIGS. 1 and 8. Such movement of the lever arm 56 will cause the second drive member 30 to move, e.g. rotate or circulate, in the first direction, e.g., clockwise in the embodiment shown in FIGS. 3A and 4. As a result, the third upright support member 26 will move downwardly because of the fixed interconnection between the second drive member 30 and the second upright support member 24. Likewise, the downward movement of the third upright support member 26 will also cause the second upright support member 24 to move downwardly because of the fixed interconnection between the third upright support member 26 and the first drive member 28 (which will move, e.g., rotate or circulate, in the second direction, e.g., counter-clockwise in the embodiment shown in FIGS. 3A and 4) and the fixed interconnection between the first drive member 28 and the first upright support member 22.

During downward movement of the support member arrangement 14, the second actuator 72 may help to control (e.g., retard or dampen) such movement. For example, the second actuator 72 may function as a counterweight or counterbalance on the second upright support member 24 so as to reduce the weight or force acting on the drive members 28 and 30.

As mentioned above, the actuator 32 may instead be configured as an automatic actuator (e.g., electric actuator). For example, the actuator 32 may include an electric motor that is configured to automatically move, e.g., rotate or circulate, the second drive member 30 in order to automatically raise and/or lower the support member arrangement 14 and the platform assembly 17. As a more specific example, such an electric motor may be configured to rotate the first gear 64 or the second gear 66.

During movement of the support member arrangement 14 between the lowered and raised positions, portions of the drive members 28, 30 that correspond to (e.g., that are connected to) the fixed connection locations 36a, 36b and 38 (e.g., the clamps 40) may each reciprocate or move between ends of the respective upright support member 24, 26. For example, during upward movement of the support member arrangement 14 from the lowered position to the raised position, the portions of the drive members 28, 30 associated with fixed connection locations 36a and 38 (e.g., the portions of the drive members 28, 30 clamped by the clamps 40 at those fixed connection locations) may each move from a location proximate an upper end of the respective upright support member 24, 26 and/or proximate a respective upper pulley 34 to a location proximate a lower end of the respective upright support member 24, 26 and/or proximate a respective lower pulley 34. The portion of the first drive member 28 associated with the fixed connection location 36b (e.g., clamped by the clamp 40 at the fixed connection location 36b), on the other hand, may move from a location proximate a lower end of the second upright support member 24 and/or proximate the respective lower pulley 34 to a location proximate an upper end of the second upright support member 24 and/or proximate the respective upper pulley 34. During downward movement of the support member arrangement 14 from the raised position to the lowered position, each of the above drive member portions may move in an opposite direction.

The lift device 10 according to the disclosure may provide numerous benefits or advantages. For example, the interconnection of the drive members 28 and 30 with the support member arrangement 14 may provide synchronized movement of the second and third upright support members 24 and 26, respectively, as the support member arrangement 14 moves between the lowered and raise positions. As another example, in an embodiment in which the actuator 32 is a manual actuator, the lift 10 can be effectively operated utilizing only manual force. In an embodiment in which the actuator 32 is an automatic actuator, the lift 10 may be efficiently operated using battery power, for example, to power the actuator. Either of the above embodiments may also be used indoors or outdoors.

A lift or lift device according to the disclosure may include a support member arrangement having more than three support members and a drive system having more than two drive members. For example, a lift device according to the disclosure may include the structure described above with respect to the lift device 10, as well as a fourth support member, such as a fourth upright support member (e.g., boom, mast, tube, column, etc.), movably associated with the third upright support member 26 (e.g., the fourth upright support member may telescopically receive the third upright support number 26), and a third drive member (e.g., strand, belt, chain, cable, or other flexible member, or any other suitable drive member) movably associated with the fourth upright support member (e.g., the third drive member may be movably received or positioned within the fourth upright support member). Furthermore, the third drive member may be fixedly connected to the third upright support member 26, and the fourth upright support member may be fixedly connected to the second drive member 30. In addition, the work platform assembly 17 may be connected to the fourth upright support member, instead of the third upright support member, and the actuator 32 may be arranged to drive the third drive member to cause movement of the support member arrangement in a similar manner as described above with respect to the lift device 10. One or more additional actuators similar to the above-described second actuator 72 may also be utilized as needed to facilitate movement of the support member arrangement between lowered and raised positions.

The following clauses describe aspects of embodiments according to the disclosure.
Clause 1. A lift device according to the disclosure may comprise a support member arrangement including a first upright support member, a second upright support member movably associated with the first upright support member, and a third upright support member movably associated with the second upright support member. The lift device may also include a drive system that is operable to move the support member arrangement between a lowered position and a raised position. The drive system may include first and second drive members and an actuator for moving the first and second drive members. The first drive member may be movably associated with the second upright support member and fixedly connected to the first upright support member and the third upright support member, and the second drive member may be movably associated with the third upright support member and fixedly connected to the second upright support member. The first and second drive members are configured to cooperate to provide synchronized movement of the second and third upright support members.
Clause 2. The lift device of the preceding clause wherein the second upright support member is configured to telescopically receive the first upright support member when the support member arrangement moves from the raised position toward the lowered position.
Clause 3. The lift device of any of the preceding clauses wherein the third upright support member is configured to telescopically receive the second upright support member when the support member arrangement moves from the raised position toward the lowered position.
Clause 4. The lift device of any of the preceding clauses wherein the first drive member is fixedly connected to the first upright support member within the second upright support member.
Clause 5. The lift device of any of the preceding clauses wherein the first drive member is positioned within the second upright support member, and the second drive member is positioned within the third upright support member.
Clause 6. The lift device of any of the preceding clauses wherein the first and second drive members each comprise a flexible drive member.
Clause 7. The lift device of any of the preceding clauses wherein the first and second drive members each comprise a reciprocatable drive member.
Clause 8. The lift device of any of the preceding clauses wherein at least one of the first and second drive members comprises a belt, chain, or cable.
Clause 9. The lift device of any of the preceding clauses wherein the actuator is connected to the third upright support member.
Clause 10. The lift device of any of the preceding clauses wherein the actuator comprises a manually operable actuator.
Clause 11. The lift device of any of the preceding clauses further comprising a work platform connected to the support member arrangement and configured to support an operator.
Clause 12. The lift device of clause 11 wherein the work platform is fixedly connected to the third upright support member.
Clause 13. The lift device of any of the preceding clauses further comprising a movable base to which the first upright support member is fixedly attached.
Clause 14. The lift device of any of the preceding clauses further comprising an additional actuator associated with the support member arrangement and configured to assist movement of the support member arrangement.
Clause 15. The lift device of clause 14 further comprising a base configured to support the support member arrangement, wherein the first upright support member is fixedly attached to the base, and the additional actuator is connected to the base and the second upright support member.
Clause 16. The lift device of any of the preceding clauses wherein the first drive member is positioned between the second upright support member and the first upright support member, and the second drive member is positioned between the third upright support member and the second upright support member.
Clause 17. The lift device of any of the preceding clauses wherein at least one of the first upright support member and the third upright support member is fixedly connected to the first drive member with a clamp, or the second upright support member is fixedly connected to the second drive member with a clamp.
Clause 18. The lift device of clause 17 wherein each clamp comprises a clamp body at least partially around which the first drive member or the second drive member is fixedly wrapped, and wherein the clamp body is fixedly connected to one of the upright support members.
Clause 19. A lift device according to the disclosure may comprise a support member arrangement including multiple support members, the multiple support members including first, second and third support members, wherein the second and third support members are movable with respect to the first support member so that the support member arrangement is movable between a lowered position and a raised position. The lift device may also include a drive system that is operable to move the support member arrangement between the lowered position and the raised position. The drive system may include a drive member that is movably associated with the second support member and fixedly connected to the first support member and the third support member.
Clause 20. A lift device according to the disclosure may comprise a movable base, and a support member arrangement including a first upright support member fixedly attached to the base, a second upright support member movably associated with the first upright support member so that the second upright support member is telescopically slidable with respect to the first upright support member, and a third upright support member movably associated with the second upright support member so that the third upright support member is telescopically slidable with respect to the second upright support member. The lift device may further include a drive system that is operable to move the support member arrangement between a lowered position and a raised position. The drive system may include first and second reciprocatable drive members and a manual actuator for moving the first and second drive members, wherein the first drive member is movably received within the second upright support member and fixedly connected to the first upright support member and the third upright support member, and the second drive member is movably received within the third upright support member and fixedly connected to the second upright support member. The first and second drive members may cooperate to provide synchronized movement of the second and third upright support members upon actuation by the manual actuator.
Clause 21. Any of the preceding clauses 1-20 in any combination.

While exemplary embodiments are described above, it is not intended that these embodiments describe all possible forms according to the disclosure. In that regard, the words used in the specification are words of description rather than limitation, and it is understood that various changes may be made without departing from the spirit and scope of the disclosure. Additionally, the features of various implementing embodiments may be combined to form further embodiments according to the disclosure.

What is claimed is:

1. A lift device comprising:
a support member arrangement including a first upright support member, a second upright support member movably associated with the first upright support member, and a third upright support member movably associated with the second upright support member; and
a drive system that is operable to move the support member arrangement between a lowered position and a raised position, the drive system including first and second drive members and an actuator for moving the first and second drive members, wherein the first drive member is movably associated with the second upright support member and fixedly connected to the first upright support member and the third upright support member, and the second drive member is movably associated with the third upright support member and fixedly connected to the second upright support member, and wherein the first and second drive members are configured to cooperate to provide synchronized movement of the second and third upright support members.

2. The lift device of claim 1 wherein the second upright support member is configured to telescopically receive the first upright support member when the support member arrangement moves from the raised position toward the lowered position.

3. The lift device of claim 1 wherein the third upright support member is configured to telescopically receive the second upright support member when the support member arrangement moves from the raised position toward the lowered position.

4. The lift device of claim 1 wherein the first drive member is fixedly connected to the first upright support member within the second upright support member.

5. The lift device of claim 1 wherein the first drive member is positioned within the second upright support member, and the second drive member is positioned within the third upright support member.

6. The lift device of claim 1 wherein the first and second drive members each comprise a flexible drive member.

7. The lift device of claim 1 wherein the first and second drive members each comprise a reciprocatable drive member.

8. The lift device of claim 1 wherein at least one of the first and second drive members comprises a belt, chain, or cable.

9. The lift device of claim 1 wherein the actuator is connected to the third upright support member.

10. The lift device of claim 9 wherein the actuator comprises a manually operable actuator.

11. The lift device of claim 1 further comprising a work platform connected to the support member arrangement and configured to support an operator.

12. The lift device of claim 11 wherein the work platform is fixedly connected to the third upright support member.

13. The lift device of claim 1 further comprising a movable base to which the first upright support member is fixedly attached.

14. The lift device of claim 1 further comprising an additional actuator associated with the support member arrangement and configured to assist movement of the support member arrangement.

15. The lift device of claim 14 further comprising a base configured to support the support member arrangement, wherein the first upright support member is fixedly attached to the base, and the additional actuator is connected to the base and the second upright support member.

16. The lift device of claim 1 wherein the first drive member is positioned between the second upright support member and the first upright support member, and the second drive member is positioned between the third upright support member and the second upright support member.

17. The lift device of claim 1 wherein at least one of the first upright support member and the third upright support member is fixedly connected to the first drive member with a clamp, or the second upright support member is fixedly connected to the second drive member with a clamp.

18. The lift device of claim 17 wherein each clamp comprises a clamp body at least partially around which the first drive member or the second drive member is fixedly wrapped, and wherein the clamp body is fixedly connected to one of the upright support members.

19. A lift device comprising:
a support member arrangement including multiple support members, the multiple support members including first, second and third support members, wherein the second and third support members are movable with respect to the first support member so that the support member arrangement is movable between a lowered position and a raised position;
a drive system that is operable to move the support member arrangement between the lowered position and the raised position, the drive system including a drive member that is movably associated with the second support member and fixedly connected to the first support member and the third support member.

20. A lift device comprising:
a movable base;
a support member arrangement including a first upright support member fixedly attached to the base, a second upright support member movably associated with the first upright support member so that the second upright support member is telescopically slidable with respect to the first upright support member, and a third upright support member movably associated with the second upright support member so that the third upright support member is telescopically slidable with respect to the second upright support member; and
a drive system that is operable to move the support member arrangement between a lowered position and a raised position, the drive system including first and second reciprocatable drive members and a manual actuator for moving the first and second drive members, wherein the first drive member is movably received within the second upright support member and fixedly connected to the first upright support member and the third upright support member, and the second drive member is movably received within the third upright support member and fixedly connected to the second upright support member, and wherein the first and second drive members cooperate to provide synchronized movement of the second and third upright support members upon actuation by the manual actuator.
